(19) United States
(12) Patent Application Publication
(10) Pub. No.: US 2022/0410538 A1
(43) Pub. Date: Dec. 29, 2022

(54) SYSTEMS AND METHODS FOR UNIFORM TRANSMISSION IN LIQUID CRYSTAL PANELS

(71) Applicant: Corning Incorporated, Corning, NY (US)

(72) Inventors: Oladapo Olalekan Bello, Horseheads, NY (US); James Gregory Couillard, Ithaca, NY (US); Michael Aaron McDonald, Painted Post, NY (US); Paul George Rickerl, Endicott, NY (US)

(21) Appl. No.: 17/780,299

(22) PCT Filed: Nov. 25, 2020
(86) PCT No.: PCT/US2020/062145

§ 371 Date: May 26, 2022

Related U.S. Application Data
(60) Provisional application No. 62/941,178, filed on Nov. 27, 2019.

(51) Int. Cl. B32B 17/10; G02F 1/1333

(52) U.S. Cl. CPC B32B 17/10036; G02F 1/133331; G02F 1/133325; B32B 2457/20; B32B 2305/55

(57) ABSTRACT

Various embodiments for configuring LC cells, LC panels, and methods of manufacturing LC panels are provided, comprising: assembling a plurality of LC panel component layers to form a curable stack, wherein the stack is configured with the LC cell, a first glass layer, a second glass layer, a first interlayer and a second interlayer, wherein each of the first interlayer and second interlayer are configured to be layers; curing the curable stack to form a liquid crystal panel; and wherein, via the first interlayer and the second interlayer, the LC panel is configured with a uniform transmission.

### CROSS REFERENCE TO RELATED APPLICATIONS

This application claims the benefit of priority under 35 U.S.C. § 119 of U.S. Provisional Application No. 62/941,178 filed Nov. 27, 2019, the content of which is incorporated herein by reference in its entirety.

### FIELD OF THE INVENTION

Broadly, the present disclosure is directed towards configurations and methods for preventing, reducing, and/or mitigating non-uniform transmissions (e.g. dark spots and/or light spots) in an LC panel and/or LC window for automotive applications and/or architectural applications.

### BACKGROUND

Liquid crystal windows present many challenges in commercialization, especially with respect to manufacture of large-dimensioned architectural windows or automotive windows. Improved performance and manufacturability are desired.

### SUMMARY

Smart windows incorporating a dimmable layer (e.g. a liquid crystal layer) can be used to control light transmission through the window, thereby improving occupant comfort and reducing energy costs. Liquid crystal windows using thick glass are very heavy, as the thick glass greatly increases the weight of the LC cell, which also contributes to difficulty transporting and installing the window.

In one aspect, an apparatus is provided, comprising: a. a liquid crystal cell (LC cell) having a first surface and a second surface, configured to retain an electrically switchable LC material, wherein the LC cell comprises: i. a first glass sheet having a thickness of 0.5 mm to not greater than 1 mm; ii. a second glass sheet having a thickness of between 0.5 to not greater than 1 mm; iii. wherein the first glass sheet and second glass sheet are configured in spaced relation with the electrically switchable LC material configured therebetween; b. a first glass layer attached to a first side of the LC cell via a first interlayer; c. a second glass layer attached to a second side of the LC cell via a second interlayer; and d. at least one polished layer on at least one of: i. the first glass layer surface in contact with the first interlayer and ii. the second glass layer surface in contact with the second interlayer.

In some embodiments, both the first glass layer and second glass layer comprise a surface polished layer.

In some embodiments, the first glass sheet and second glass sheet comprise a fusion formed glass.

In some embodiments, at least one of the first glass sheet and second glass sheet the first glass sheet is selected with a coefficient of thermal expansion (CTE) to correspond to the CTE of at least one of the first glass layer and the second glass layer.

In some embodiments, the first glass sheet is selected to have a coefficient of thermal expansion (CTE) to correspond to the CTE of the first glass layer and the second glass sheet is selected to have a coefficient of thermal expansion (CTE) to correspond to the CTE of the second glass layer.

In some embodiments, the first glass sheet and second glass sheet comprise a strengthened glass or an unstrengthened glass.

In some embodiments, the first glass sheet and second glass sheet comprise an alumino-borosilicate glass.

In some embodiments, the first glass layer and second glass layer comprise a float glass.

In some embodiments, the first glass layer and second glass layer comprise a soda lime glass.

In some embodiments, the first interlayer and second interlayer are selected from: a UV curable interlayer material; a low modulus interlayer material; an ionomer.

In some embodiments, the first interlayer and second material are the same material.

In some embodiments, the first interlayer and second interlayer are different materials.

In some embodiments, the first interlayer and second interlayer each have a thickness ranging between 0.5 mm and 2.3 mm.

In some embodiments, the first interlayer and second interlayer have the same thickness.

In some embodiments, the first interlayer and second interlayer have different thicknesses.

In one aspect, an apparatus is provided, comprising: a. a liquid crystal cell (LC cell) having a first surface and a second surface, configured to retain an electrically switchable LC material, wherein the LC cell comprises: i. a first glass sheet having a first sheet CTE and a second glass sheet having a second sheet CTE configured in spaced relation with the electrically switchable LC material configured therebetween; b. a first glass layer having a first layer CTE and attached to a first side of the LC cell via a first interlayer; c. a second glass layer having a second CTE and attached to a second side of the LC cell via a second interlayer; d. at least one polished layer on at least one of: i. the first glass layer surface in contact with the first interlayer and ii. the second glass layer surface in contact with the second interlayer; e. wherein at least one of the first sheet CTE is selected to correspond to the first layer CTE; and the second sheet CTE is selected to correspond to the second layer CTE.

In some embodiments, the first sheet CTE is selected to correspond to the first layer CTE; and the second sheet CTE is selected to correspond to the second layer CTE.

In some embodiments, the first glass layer surface in contact with the first interlayer comprises a polished layer and the second glass layer surface in contact with the second interlayer comprises a polished layer.

In some embodiments, at least one of: a first glass sheet is configured with a thickness of 0.5 mm to not greater than 1 mm and a second glass sheet is configured with a thickness of between 0.5 to not greater than 1 mm.

In some embodiments, a first glass sheet is configured with a thickness of 0.5 mm to not greater than 1 mm and a second glass sheet is configured with a thickness of between 0.5 to not greater than 1 mm.

In some embodiments, the first interlayer and second interlayer are selected from: a UV curable interlayer material; a low modulus interlayer material; an ionomer, and combinations thereof.

In some embodiments, the first interlayer and second material are the same material.

In some embodiments, the first interlayer and second interlayer are different materials.

In some embodiments, the first interlayer and second interlayer each have a thickness ranging between 0.5 mm and 2.3 mm.

In some embodiments, the first interlayer and second interlayer have the same thickness.

In some embodiments, the first interlayer and second interlayer have different thicknesses.

In one aspect, an apparatus is provided, comprising: a. a liquid crystal cell (LC cell) having a first surface and a second surface, configured to retain an electrically switchable LC material, wherein the LC cell comprises: i. a first glass sheet and a second glass sheet configured in spaced relation with the electrically switchable LC material configured therebetween; b. a first interlayer configured to attach a first glass layer to a first side of the LC cell and a second interlayer configured to attach a second glass layer to a second side of the LC cell, wherein the first interlayer and second interlayer are selected from: a UV curable interlayer material; a low modulus interlayer material; an ionomer, and combinations thereof; c. at least one polished layer on at least one of: i. the first glass layer surface in contact with the first interlayer and ii. the second glass layer surface in contact with the second interlayer.

In some embodiments, the first glass sheet has a first sheet CTE and a second glass sheet has a second sheet CTE, wherein at least one of: the first sheet CTE is selected to correspond to a first layer CTE of the first glass layer and the second sheet CTE is selected to correspond to a second layer CTE of the second glass layer.

In some embodiments, the first sheet CTE is selected to correspond to the first layer CTE and the second sheet CTE is selected to correspond to the second layer CTE.

In some embodiments, the first interlayer and second interlayer each have a thickness ranging between 0.5 mm and 2.3 mm.

In some embodiments, the first interlayer and second interlayer have the same thickness.

In some embodiments, the first interlayer and second interlayer have different thicknesses.

In some embodiments, at least one of: a first glass sheet is configured with a thickness of 0.5 mm to not greater than 1 mm and a second glass sheet is configured with a thickness of between 0.5 to not greater than 1 mm.

In some embodiments, a first glass sheet is configured with a thickness of 0.5 mm to not greater than 1 mm and a second glass sheet is configured with a thickness of between 0.5 to not greater than 1 mm.

In one aspect, an apparatus is provided, comprising: a. a liquid crystal cell (LC cell) having a first surface and a second surface, configured to retain an electrically switchable LC material, wherein the LC cell comprises: i. a first glass sheet and a second glass sheet configured in spaced relation with the electrically switchable LC material configured therebetween; b. a first interlayer configured to attach a first glass layer to a first side of the LC cell and a second interlayer configured to attach a second glass layer to a second side of the LC cell, wherein the first interlayer and second interlayer each have a thickness ranging between 0.5 mm and 2.3 mm; c. at least one polished layer on at least one of: i. the first glass layer surface in contact with the first interlayer and the second glass layer surface in contact with the second interlayer.

In some embodiments, the first interlayer and second interlayer have the same thickness.

In some embodiments, the first interlayer and second interlayer have different thicknesses.

In some embodiments, the first interlayer and second interlayer are selected from: a UV curable interlayer material; a low modulus interlayer material; an ionomer, and combinations thereof.

In some embodiments, the first interlayer and second material are the same material.

In some embodiments, the first interlayer and second interlayer are different materials.

In some embodiments, the first glass sheet has a first sheet CTE and a second glass sheet has a second sheet CTE, wherein at least one of: the first sheet CTE is selected to correspond to a first layer CTE of the first glass layer and the second sheet CTE is selected to correspond to a second layer CTE of the second glass layer.

In some embodiments, the first sheet CTE is selected to correspond to the first layer CTE; and the second sheet CTE is selected to correspond to the second layer CTE.

In some embodiments, at least one of: a first glass sheet is configured with a thickness of 0.5 mm to not greater than 1 mm and a second glass sheet is configured with a thickness of between 0.5 to not greater than 1 mm.

In some embodiments, a first glass sheet is configured with a thickness of 0.5 mm to not greater than 1 mm and a second glass sheet is configured with a thickness of between 0.5 to not greater than 1 mm.

In one aspect, an apparatus is provided, comprising: a. a liquid crystal cell (LC cell) having a first surface and a second surface, configured to retain an electrically switchable LC material, wherein the LC cell comprises: i. wherein a first glass sheet a second glass sheet configured in spaced relation with the electrically switchable LC material configured therebetween, wherein at least one of the first glass sheet and second glass sheet have a thickness selected from the range of: 0.5 mm to not greater than 1 mm; and b. a first interlayer configured to attach a first glass layer to a first side of the LC cell and a second interlayer configured to attach a second glass layer to a second side of the LC cell, wherein the first interlayer and second interlayer each have a thickness ranging between 0.5 mm and 2.3 mm.

In some embodiments, each of the first glass sheet and second glass sheet have a thickness selected from the range of: 0.5 mm to not greater than 1 mm.

In some embodiments, the first glass sheet and second glass sheet have the same thickness.

In some embodiments, the first glass sheet and second glass sheet have different thicknesses.

In some embodiments, the first glass sheet and second glass sheet comprise a fusion formed glass.

In some embodiments, the first interlayer and second interlayer have the same thickness.

In some embodiments, the first interlayer and second interlayer have different thicknesses.

In some embodiments, there is at least one polished layer on at least one of: i. the first glass layer surface in contact with the first interlayer and ii. the second glass layer surface in contact with the second interlayer.

In some embodiments, both the first glass layer and second glass layer comprise a surface polished layer.

In some embodiments, the first interlayer and second interlayer are selected from: a UV curable interlayer material; a low modulus interlayer material; an ionomer, and combinations thereof.

In some embodiments, the first interlayer and second material are the same material.

In some embodiments, the first interlayer and second interlayer are different materials.

In some embodiments, the first glass sheet has a first sheet CTE and a second glass sheet has a second sheet CTE, wherein at least one of: the first sheet CTE is selected to correspond to a first layer CTE of the first glass layer and the second sheet CTE is selected to correspond to a second layer CTE of the second glass layer.

In some embodiments, the first sheet CTE is selected to correspond to the first layer CTE; and the second sheet CTE is selected to correspond to the second layer CTE.

In one aspect, an apparatus is provided, comprising: a. a liquid crystal cell (LC cell) having a first surface and a second surface, configured to retain an electrically switchable LC material, wherein the LC cell comprises: i. wherein a first glass sheet a second glass sheet configured in spaced relation with the electrically switchable LC material configured therebetween, wherein at least one of the first glass sheet and second glass sheet have a thickness selected from the range of: 0.5 mm to not greater than 1 mm; and ii. a first interlayer configured to attach a first glass layer to a first side of the LC cell and a second interlayer configured to attach a second glass layer to a second side of the LC cell, wherein the first interlayer and second interlayer wherein the first interlayer and second interlayer are selected from: a UV curable interlayer material; a low modulus interlayer material; an ionomer, and combinations thereof.

In some embodiments, each of the first glass sheet and second glass sheet have a thickness selected from the range of: 0.5 mm to not greater than 1 mm.

In some embodiments, the first glass sheet and second glass sheet have the same thickness.

In some embodiments, the first glass sheet and second glass sheet have different thicknesses.

In some embodiments, the first glass sheet and second glass sheet comprise a fusion formed glass.

In some embodiments, the first interlayer and second interlayer are configured from the same material.

In some embodiments, the first interlayer and second interlayer are configured from different materials.

In some embodiments, the first glass sheet has a first sheet CTE and a second glass sheet has a second sheet CTE, wherein at least one of: the first sheet CTE is selected to correspond to a first layer CTE of the first glass layer and the second sheet CTE is selected to correspond to a second layer CTE of the second glass layer.

In some embodiments, the first sheet CTE is selected to correspond to the first layer CTE; and the second sheet CTE is selected to correspond to the second layer CTE.

In some embodiments, the apparatus comprises at least one polished layer on at least one of: i. the first glass layer surface in contact with the first interlayer and ii. the second glass layer surface in contact with the second interlayer.

In some embodiments, both the first glass layer and second glass layer comprise a surface polished layer.

In some embodiments, the first interlayer and second interlayer each have a thickness ranging between 0.5 mm and 2.3 mm.

In some embodiments, the first interlayer and second interlayer have the same thickness.

In some embodiments, the first interlayer and second interlayer have different thicknesses.

In one aspect, an apparatus is provided, comprising: a. a liquid crystal cell (LC cell) having a first surface and a second surface, configured to retain an electrically switchable LC material, wherein the LC cell comprises: i. a first glass sheet and a second glass sheet configured in spaced relation with the electrically switchable LC material configured therebetween; ii. a first glass sheet having a first sheet CTE and a second glass sheet having a second sheet CTE configured in spaced relation with the electrically switchable LC material configured therebetween; a. a first glass layer having a first layer CTE and attached to a first side of the LC cell via a first interlayer; b. a second glass layer having a second CTE and attached to a second side of the LC cell via a second interlayer; wherein the first interlayer and second interlayer each have a thickness ranging between 0.5 mm and 2.3 mm; c. wherein at least one of the first sheet CTE is selected to correspond to the first layer CTE; and the second sheet CTE is selected to correspond to the second layer CTE.

In some embodiments, the first interlayer and second interlayer have the same thickness.

In some embodiments, the first interlayer and second interlayer have different thicknesses.

In some embodiments, the first sheet CTE is selected to correspond to the first layer CTE; and the second sheet CTE is selected to correspond to the second layer CTE.

In some embodiments, at least one of: a first glass sheet is configured with a thickness of 0.5 mm to not greater than 1 mm and a second glass sheet is configured with a thickness of between 0.5 to not greater than 1 mm.

In some embodiments, a first glass sheet is configured with a thickness of 0.5 mm to not greater than 1 mm and a second glass sheet is configured with a thickness of between 0.5 to not greater than 1 mm.

In some embodiments, the first interlayer and second interlayer are selected from: a UV curable interlayer material; a low modulus interlayer material; an ionomer, and combinations thereof.

In some embodiments, the first interlayer and second interlayer are each configured from the same material.

In some embodiments, the first interlayer and second interlayer are each configured from different material.

In some embodiments, the apparatus comprises at least one polished layer on at least one of: i. the first glass layer surface in contact with the first interlayer and ii. the second glass layer surface in contact with the second interlayer.

In some embodiments, both the first glass layer and second glass layer comprise a surface polished layer.

In one aspect, a method is provided, comprising: assembling a plurality of LC panel component layers to form a stack, wherein the LC panel component layers comprise: a first glass layer having a first surface and a second surface; a first interlayer; an LC cell having a first glass sheet and a second glass sheet, wherein the glass sheets are configured in spaced relation from each other such that an LC functional material is configured therebetween; a second interlayer; and the second glass layer, having a first surface and a second surface; selectively positioning at least one of: the first glass layer and the second glass layer across the stack to mitigate an additive distortion in the stack from at least one of: the first glass layer and second glass layer; removing any entrained air between the LC panel component layers of the stack to form a curable stack; curing the curable stack to form a liquid crystal panel, wherein at least one of: the first glass sheet and second glass sheet are each configured with a CTE to correspond to a respective CTE of the first glass layer and second glass layer; and wherein the first glass sheet and second glass sheet are each configured with a thickness ranging from at least 0.5 mm to not greater than 1 mm.

In some embodiments, the selectively positioning further comprises at least one of: orthogonally positioning the first glass layer from a second glass layer to selectively position an interlayer-facing surface of the first glass layer with an interlayer-facing surface of the second glass layer; determining a smoother side from the first surface and the second surface of the first glass layer, where smoother comprises at least one of: fewer out-of-plane discontinuities and/or lower out-of-plane discontinuities, and positioning the smoother side towards the first interlayer; determining a smoother side from the first surface and the second surface of the second glass layer, where smoother comprises at least one of: fewer out-of-plane discontinuities and/or lower out-of-plane discontinuities, and positioning the smoother side of the second glass layer towards the second interlayer; and determining a smoother side from the first surface and the second surface of the first glass layer, where smoother comprises at least one of: fewer out-of-plane discontinuities and/or lower out-of-plane discontinuities, positioning the smoother side towards the first interlayer; determining a smoother side from the first surface and the second surface of the second glass layer, where smoother comprises at least one of: fewer out-of-plane discontinuities and/or lower out-of-plane discontinuities, and positioning the smoother side of the second glass layer towards the second interlayer.

In one aspect, a method is provided, comprising: assembling a plurality of LC panel component layers to form a stack, wherein the LC panel component layers comprise: a first glass layer having a first surface and a second surface; a first interlayer; an LC cell having a first glass sheet and a second glass sheet, wherein the glass sheets are configured in spaced relation from each other such that an LC functional material is configured therebetween; a second interlayer; and the second glass layer, having a first surface and a second surface; selectively positioning at least one of: the first glass layer and the second glass layer across the stack to mitigate an additive distortion in the stack from at least one of: the first glass layer and second glass layer; removing any entrained air between the LC panel component layers of the stack to form a curable stack; curing the curable stack to form a liquid crystal panel, wherein at least one of: the first interlayer and second interlayer are each selected from: a UV curable interlayer material; a low modulus interlayer material; an ionomer, and combinations thereof; and wherein the first glass interlayer and second interlayer are each configured with a thickness ranging from at least 0.5 mm to not greater than 2.3 mm.

Additional features and advantages will be set forth in the detailed description which follows and will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary and are intended to provide an overview or framework to understanding the nature and character of the disclosure as it is claimed.

The accompanying drawings are included to provide a further understanding of principles of the disclosure, and are incorporated in, and constitute a part of, this specification. The drawings illustrate one or more embodiment(s) and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following aspects.

### BRIEF DESCRIPTION OF THE DRAWINGS

These and other features, aspects and advantages of the present disclosure are better understood when the following detailed description of the disclosure is read with reference to the accompanying drawings, in which:

FIG. 1A depicts a schematic cut-away side view of an embodiment of a liquid crystal (LC) panel in accordance with various embodiments of the present disclosure.

FIG. 1B depicts a close-up cut away side schematic view of a region of FIG. 1A, showing a close-up of a portion of the panel, depicting the second glass layer , the interlayer, the conductive layer, and the LC region, which includes an LC mixture and a plurality of spacers, in accordance with one or more embodiment of the present disclosure.

FIG. 2 depicts a contour map of a representative sample of a first glass layer 12 or second glass layer 14 utilized in the LC panel 10 as described herein. The float glass has a surface waviness/contoured topography at production, which can be exacerbated with tempering to provide a surface topography similar to that of the representative example in FIG. 2. This tempered soda lime glass exhibits a surface discontinuity (out-of-plane discontinuity), with peaks and troughs averaging ˜50 μm high/deep, which provides challenges in laminating to manufacture a liquid crystal panel 10.

FIG. 3A depicts a schematic view of an embodiment of an LC panel, showing an LC cell laminated via first and second interlayers, to corresponding first and second glass layers, in accordance with one or more aspects of the present disclosure.

FIG. 3B depicts a schematic view of an embodiment of an LC window, showing an LC panel configured with a frame, seal between frame and panel, and with a coating on a surface of the panel, in accordance with one or more aspects of the present disclosure.

FIG. 4 depicts a method of making an LC panel, in accordance with various embodiments of the present disclosure.

FIG. 5 depicts a flow chart of an embodiment of a method of making an LC panel, in accordance with one or more embodiments of the present disclosure.

FIG. 6 depicts a flow chart of an alternative embodiment of a method of making an LC panel, in accordance with one or more embodiments of the present disclosure.

FIG. 7 provides a flow chart depicting various embodiments of a method for making an LC panel, where various embodiments are depicted for selectively positioning the first glass layer and the second glass layer, in accordance with embodiments of the present disclosure.

FIG. 8 depicts another embodiment a method in accordance with the present disclosure, where both surface polishing and selectively positioning (one, two, and/or three embodiments provided herein) are included, in accordance with various embodiments of the present disclosure.

FIG. 9A-C depicts three comparative illustrations of configuring two glass layers with corresponding bow based on configuration of glass layers (FIG. 9A) or contradicting bow based on configuration of glass layers (FIGS. 9B and 9C), in accordance with one or more aspects of the present disclosure. Bow can be measured in accordance with ASTM C1172.

FIG. 10 depicts a schematic cut-away side view of an embodiment of an LC cell configured with respect to various embodiments of the present disclosure.

FIG. 11 depicts a flow chart for an embodiment of a method of making an LC panel in accordance with various embodiment of the present disclosure.

FIG. 12 depicts a schematic cut-away side view of an embodiment of an LC panel in accordance with various embodiments of the present disclosure.

FIG. 13 depicts a table providing various embodiments of manufacturing an LC panel, to thereby reduce, prevent and/or eliminate defects/non-uniform transmissions (e.g. spots, including dark spots or light spots) in the resulting LC panel, in accordance with various embodiments of the present disclosure.

### DETAILED DESCRIPTION OF THE DRAWINGS

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

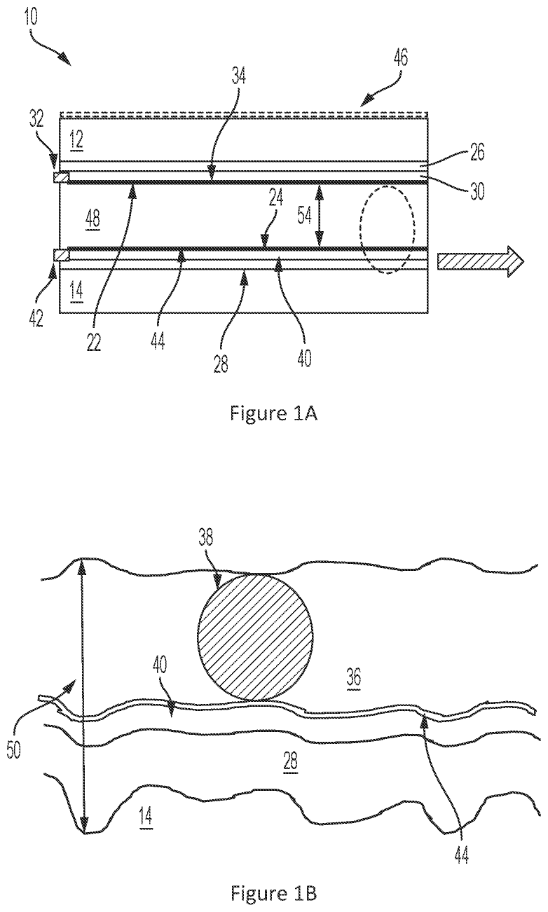

FIG. 1A depicts a schematic cut-away side view of a liquid crystal (LC) panel.

Referring to FIG. 1A, a schematic cut-away side view of an embodiment of a liquid crystal panel 10 is depicted, illustrating the LC cell 20 configured (sandwiched) between two glass layers (e.g. a first glass layer 12 and a second glass layer 14), with corresponding interlayers (e.g. first interlayer 26 and second interlayer 36) positioned between each of the first glass layer 12 and the first side of the LC cell 22, and the second glass layer 14 and the second side of the LC cell 24.

The liquid crystal cell 20 is configured with two glass layers, a first glass layer 30 and a second glass layer 40, set apart in spaced relation from each other with a liquid crystal region 48 defined therebetween. Each of the first glass layer 30 and the second glass layer 40 is configured with a conductive layer (e.g. first conductive layer 34 and second conductive layer 44) where each conductive layer (34, 44) is configured between the LC region 48 and the first or second glass sheets 30, 40, such that the conductive layers 34, 44 are configured in electrical communication with the liquid crystal region.

The liquid crystal region 48 includes a plurality of spacers 38 and an LC mixture 36. The spacers 38 are provided in spaced relation throughout the LC mixture 36, such that the spacers 38 are configured to promote a cell gap that is substantially uniform (e.g. not exceeding a predefined threshold) from one position within the LC cell 20 to another position in the LC cell 20. The LC mixture 36 can include: at least one liquid crystal material, at least one dye, at least one host material, and/or at least one additive. The LC mixture 36 is configured to electrically switch/actuate, thereby providing the actuation element in a corresponding liquid crystal cell 20, liquid crystal panel 10, and liquid crystal window to provide a contrast (e.g. dark) and a non-contrast (e.g. clear) state when actuated. Actuation of the LC mixture 36 is completed by the electrical connections via first electrode 32 (adjacent to the first major side 22 of the LC cell 20) and the second electrode 42 (adjacent to the second major side 24 of the LC cell 20). The electrode (one of 32 and 42) is configured to direct an electrical current or potential from a power source through the corresponding electrode acting as anode, through the corresponding conductive layer (one of 34 or 44), through the LC region 48 to actuate the LC mixture 36, through the corresponding conductive layer (the other of 34 or 44) and exiting the system through the electrode (the other of 32 and 42). By turning on and off the power source, and thereby, the current running through the LC mixture, the LC mixture is actuated from a first transmission state to a second transmission state (where the first transmissions state is different from the second transmission state).

As shown, the LC panel 10 includes a first glass layer 12, a second glass layer 14, an LC cell 20, a first interlayer 26, and a second interlayer 28. The LC cell 20 includes a liquid crystal material 36 (e.g. molecules, dyes, and/or additives), spacers 38 (configured to cooperate with the glass layers to maintain the cell gap in the LC cell), a first conductive layer 34, a second conductive layer 44, a first electrode 32, a second electrode 42, a first sheet of glass 30, and a second sheet of glass 40.

In some embodiments, the first glass layer 12 and second glass layer 14 are thick. In some embodiments, the first glass layer and the second glass layer each have a thickness of at least 3 mm thick. In some embodiments, the first glass layer and the second glass layer each have a thickness of at least 3 mm thick to not greater than 7 mm thick.

In some embodiments, the first sheet of glass 30 and second sheet of glass 40 are thin. In some embodiments, the first glass sheet and the second glass sheet each have a thickness of at not greater than 1 mm thick. In some embodiments, the first glass layer and the second glass layer each have a thickness of at least 0.3 mm thick to not greater than 1 mm thick.

In some embodiments, the first sheet of glass and second sheet of glass are thinner than the first layer of glass 12 and second layer of glass 14.

In some embodiments, the glass sheets (30, 40) are configured in the LC cell 20, adjacent to major surfaces 22, 24 of the LC cell and adjacent to the LC material 36 to retain LC components (e.g. conductive layers (34, 44), LC material 36, spacers 38) in place. In some embodiments, first interlayer 26 is configured between first glass layer 12 and first sheet of glass 30 (first surface 22 of LC cell 20). In some embodiments, second interlayer 28 is configured between second layer of glass 14 and second sheet of glass 40 (second surface 24 of LC cell 20).

In some embodiments, the glass sheet (e.g. first sheet of glass 30 or second sheet of glass 40) is configured with a thickness of less than 1 mm; less than 0.8 mm, less than 0.7 mm, less than 0.5 mm, or less than 0.3 mm. In some embodiments, the first sheet of glass 30 has the same thickness as the second sheet of glass 40. In some embodiments, the first sheet of glass 30 has a different thickness than the second sheet of glass 40.

For example, conductive layer (34 or 44) is configured in the LC cell 20 between the sheet of glass (30 or 40) and the LC region 48. The conductive layer (34 or 44) is attached to one or more electrodes (32 or 34) (e.g. configured to communicate with the conductive layers and a power source (not shown) to direct an electric field across the LC cell 20, actuating the LC panel/smart window to an on position (having a first contrast) and off position (having a second contrast)), based on whether the electric field is on or off

Each conductive layer includes a conductive film, for example, a transparent conductive oxide. Some non-limiting examples of thin conductive film is ITO (indium tin oxide), FTO (fluorine-doped tin oxide), or metals.

In some embodiments, an alignment layer such as polyimide may be disposed between the thin conductive film and the LC material to promote orientation of the LC molecules (within the LC material 36) with a desired angle.

FIG. 1B depicts a close-up cut away side view of a region of FIG. 1A, showing a close-up of the second glass layer 14 (e.g. tempered SLG), second interlayer 28, and second glass sheet 40 of the LC cell 20, further depicting the LC region's 48 LC mixture 36 and a spacer 38 retained in the LC cell 20. As shown in FIG. 1B, the surface discontinuity of the first glass layer and second glass layer 14 (here, only second glass layer shown) as compared to the second layer of glass 40 is apparent. In this illustrated example, the surface discontinuity attributed to the area 50 of the LC panel 10 is an area of a non-uniformity/discontinuity in the LC cell 20. This example may be viewed by an observer as a dark spot in the LC panel 10. The spacers 38 are configured to extend across the cell gap of the LC cell 20.

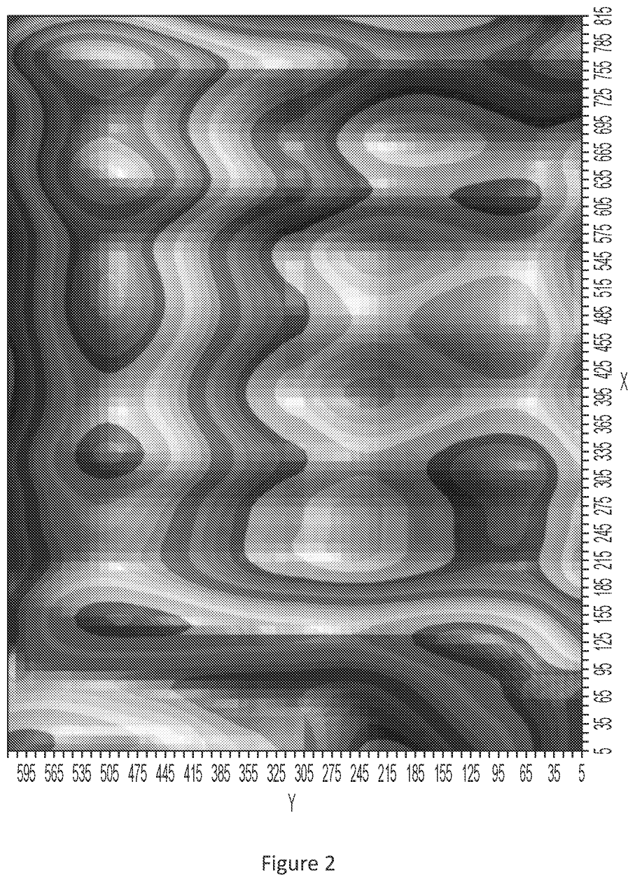

FIG. 2 depicts a contour map of a representative sample of a first glass layer 12 or second glass layer 14 utilized in the LC panel 10 as described herein. The float glass has a surface waviness/contoured topography at production, which can be exacerbated with tempering to provide a surface topography similar to that of the representative example in FIG. 2. This tempered soda lime glass exhibits a surface discontinuity (out-of-plane discontinuity), with peaks and troughs averaging ˜50 μm high/deep, which provides challenges in laminating to manufacture a liquid crystal panel 10.

In one non-limiting example, the waviness can be analytically determined through mechanical or optical measurement devices and in accordance with standard methods. In one non-limiting example, the waviness can be determined by measurement in accordance with ASTM C1651: Standard Test Method for Measurement of Roll Wave Optical Distortion in Heat-Treated Flat Glass. Other standard methods may also be utilized to understand the surface-waviness of the flat glass layers in accordance with one or more embodiments disclosed herein.

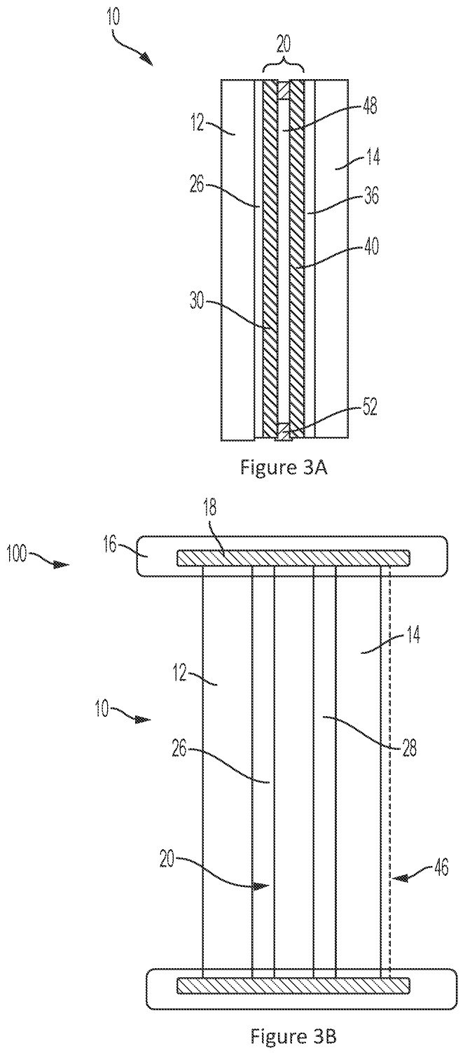

FIG. 3A depicts a schematic cut away side view of an embodiment of a single cell liquid crystal panel 10, which illustrates an LC cell laminated onto two glass layers (12, 14) via two interlayers (26, 28) to form an LC panel 10. The LC panel depicts a symmetrical component configuration, with an axis drawn through the LC material 48, from one portion of the depicted LC cell seal 52 towards the other depicted LC cell seal 52.

FIG. 3B depicts a schematic cut-away side view of an embodiment of a single cell liquid crystal window 100. The LC window 100 includes an LC cell 20 embodied within a panel 10, the panel also having first interlayer 26, second interlayer 28, first glass layer 12, and second glass layer 14. The LC window 100 is configured with a frame 16 configured on an edge of the LC panel 10, with a seal 18 configured between at least a portion of the frame 16 and at least a portion of an edge of the panel 10 to provide compressive engagement of the panel 10 within the frame 16 without damaging the edge of the panel 10. Also, FIG. 3B depicts an optional coating 46 on a surface of the LC panel 10. Here, the coating is configured on the outer surface of the second layer of glass 14 on the LC panel 10.

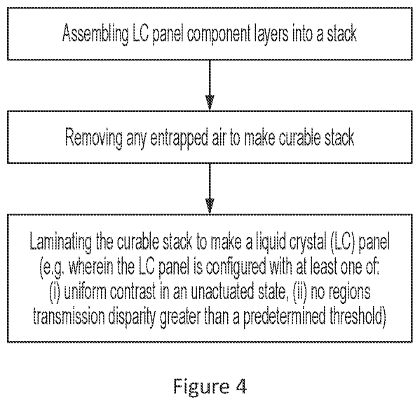

FIG. 4 depicts a method of making an LC panel. As shown, the lamination process includes assembling the LC panel component layers into a stack. The various component layers, including a first glass layer, a first interlayer, an LC cell, a second interlayer, and a second glass layer are placed into contact with one another to form the stack. The interlayer is selected from the group of: polymers and ionomers. As a non-limiting example, the interlayer comprises PVB (polyvinyl butyral) at a thickness of 0.76 mm.

Next, the lamination process includes removing any entrapped or entrained air between the various layers of the stack to form a curable stack. Non-limiting examples of air removal include: nip rolling, using an evacuation pouch, vacuuming via at least one vacuum ring, or a laminating via a flatbed laminator.

Laminating is completed on the curable stack in order to bond the first glass layer and the second glass layer to major surfaces of the LC cell (e.g. as shown in FIG. 1A, generally opposing major surfaces of the LC cell via the corresponding first and second interlayers, which attach (e.g. bond) the first glass layer onto the first surface of the LC cell and the second glass layer on the second side of the LC cell. Non-limiting examples of laminating include utilizing a flatbed laminator or an autoclave. After laminating for a duration of time, at a temperature, and under a target pressure, the curable stack is formed into a liquid crystal (LC) panel.

In a non-limiting example, the LC panel is made into a liquid crystal window by configuring a seal and a frame around an outer edge of the LC panel, to retain the LC panel within the frame. Additionally, electrical communication is configured from a power supply to the electrodes so that the LC window can be actuated via an electrical field directed across the LC window via the electrodes, conductive layers, and LC material.

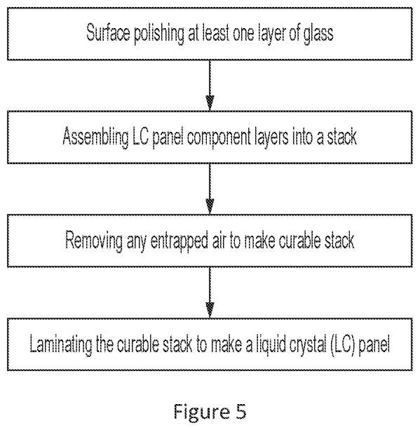

Referring to the following figures, FIGS. 5-9 are generally directed towards embodiments of methods to configure the tempered SLG layer or layers in the LC panel during manufacture to prevent, reduce, and/or eliminate mura (e.g. dark spots). Non-limiting examples include surface polishing the inner surface of one or both of the first glass layer and second glass layer, and/or selectively positioning the first glass layer and second glass layer relative to each other in the stack configuration.

FIG. 5 depicts a flow chart of an embodiment of a method is depicted, in accordance with one or more embodiments of the present disclosure. Referring to FIG. 5, a method provides surface polishing at least one of the tempered SLG layers, assembling the LC panel component layers into a stack, removing any entrapped air to make a curable stack, followed by laminating the curable stack to make a LC panel, wherein, via the surface polishing step, the LC panel, when in a static contrast state, is configured with at least one of: (i) no regions having a transmission disparity greater than a predetermined threshold (as compared to adjacent regions), and/or (ii) uniform contrast/no visually observable dark spots (e.g. in either contrast state).

In some embodiments, surface polishing means surface polishing an inner side (e.g. facing the LC cell and adjacent to the interlayer) of at least one of: the first layer of SLG, the second layer of SLG, or both layers of SLG.

In some embodiments, surface polishing means surface polishing an inner side (e.g. facing the LC cell and adjacent to the interlayer) of both the first layer of SLG and the second layer of SLG.

In some embodiments, surface polishing is configured to remove any tall peaks from the SLG inner surface out-of-plan discontinuity. In some embodiments, surface polishing is configured to remove peaks extending above 50 microns from the surface plane of the SLG. In some embodiments, surface polishing is configured to reduce out-of-plane discontinuities by 75%, or by about 50%, or by about 25%, or by about 10%. In some embodiments, surface polishing is configured to reduce out-of-plane discontinuities by 75% (e.g. from 50 microns to 12.5 microns), or by about 50% (e.g. from 50 microns to 25 microns), or by about 25% (e.g. from 50 microns to 37.5 microns), or by about 10% (from 50 microns to 40 microns).

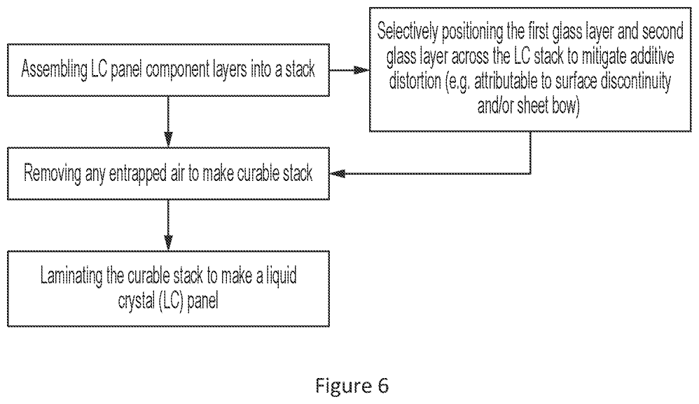

FIG. 6 depicts a flow chart of an alternative embodiment of a method of making an LC panel, in accordance with one or more embodiments of the present disclosure. Referring to FIG. 6, a method of making an LC panel is shown, with an alternative embodiment of selectively positioning the first glass layer and the second glass layer across the LC stack to mitigate additive distortion (e.g. attributable to one or both SLG surface discontinuity and/or one or both SLG layer bow).

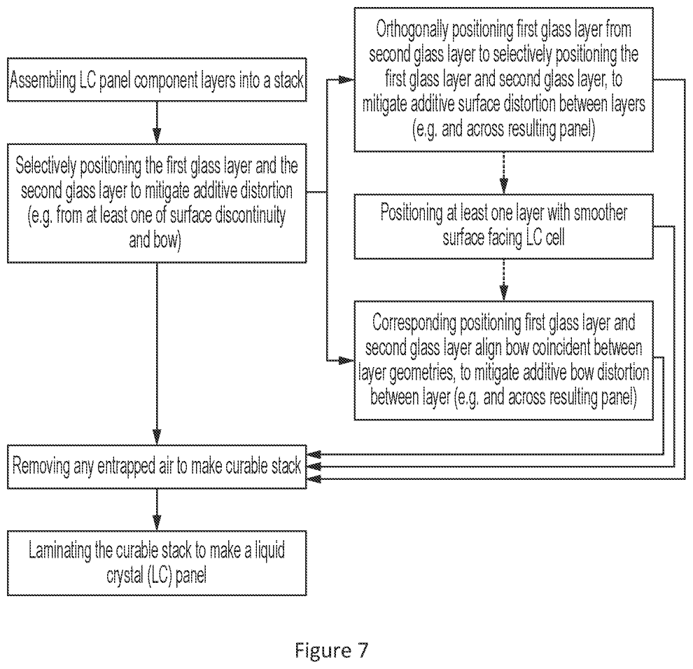

FIG. 7 provides three embodiments for selectively positioning the first glass layer and second glass layer, in accordance with embodiments of the present disclosure. As shown in FIG. 7, one embodiment of selectively positioning the first glass layer and second glass layer includes positioning the layers orthogonally to each other. In such a configuration, when both inner layers of the SLG have quasiperiodic surface discontinuities (e.g. example of quasiperiodic representation depicted in FIG. 2), by orthogonally positioning the layers relative to each other (e.g. one sheet positioned at a 90 degree rotation or 270 degree rotation relative to the other layer). Other angles of rotation and alignment are permissible, but those corresponding to quadrangle (e.g. square and rectangle) are provided herein for illustrative purposes.

In a second embodiment, selectively positioning comprises flipping the orientation of at least one SLG layer. For instance, one side of SLG may have significantly more surface discontinuities than the other, as a function of manufacture from the float or tempering process. Thus, by positioning the smoother surface (e.g. the surface with fewer/lesser surface discontinuities) of at least one SLG layer (or both SLG layers) towards the LC cell, dark spots can be prevented, reduced, and/or eliminated in lamination.

In a third embodiment, selectively positioning comprises positioning the first glass layer and the second glass layer such that the layers have in corresponding aligning bow coincident between sheet geometries. In this configuration, layers are positioned to mitigate bow (e.g. additive bow distortion between layers).

As shown in FIG. 7, selectively positioning can include one, two, or all three embodiments provided in FIG. 7, in accordance with various aspects of the present disclosure.

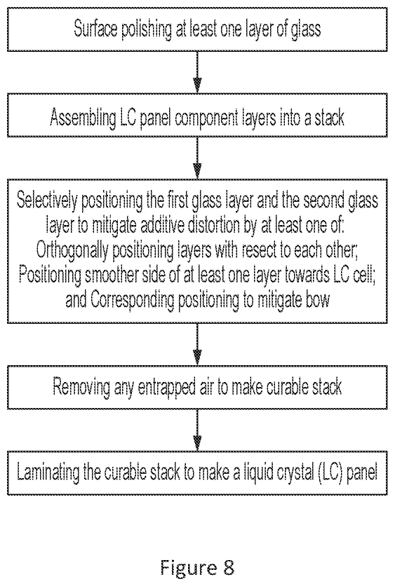

FIG. 8 depicts another embodiment a method in accordance with the present disclosure, where both surface polishing and selectively positioning (one, two, or all three embodiments provided herein) are included, in accordance with various embodiments of the present disclosure.

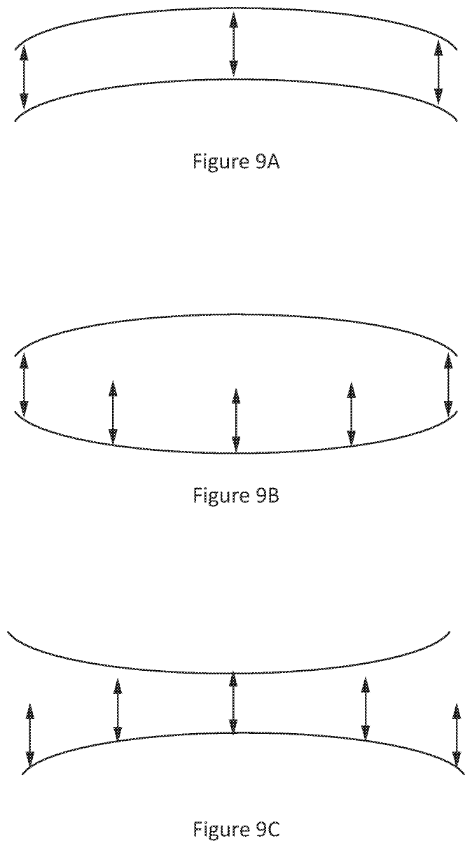

FIG. 9A-C depicts three comparative illustrations of configuring two glass layers with corresponding bow (FIG. 9A) or contradicting bow (FIGS. 9B and 9C).

Referring to FIG. 9A, two glass layers are configured with corresponding bow, to mitigate the additive bow by corresponding the layers to maintain coincident orientations of like geometries. To highlight the uniformity in spacing in FIG. 9A and the comparative gaps in FIGS. 9B and 9C, arrows having the same length are positioned between the two glass layers of each example, and there are significant gaps in the example configurations of FIG. 9B (e.g. in the central region) and 9C (e.g. at the edges/end regions).

FIG. 9A provides the two glass layers which are configured (selectively positioned) with a coincident spooning pattern, in accordance with various embodiments of the present disclosure.

In contrast, FIG. 9B is believed to result in significant uniformity issues based on the cell gap differences attributable to the SLG layer configuration (i.e. generally bowing away from each other at the center).

Similarly, FIG. 9C is believed to result in significant uniformity issues based on the cell gap differences attributable to the SLG layer configuration (i.e. generally bowing away from each other at the edges/ends).

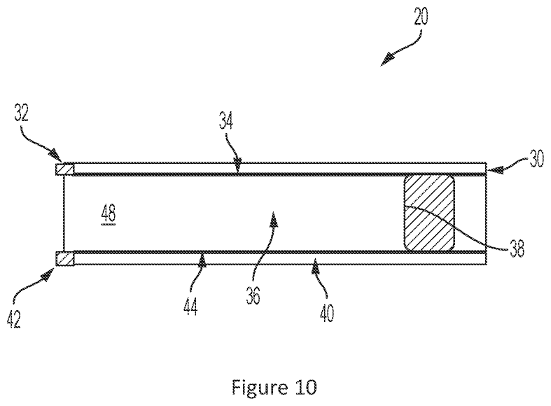

FIG. 10 depicts a schematic embodiment of an LC cell configured with respect to various embodiments of the present disclosure. Referring to the following figure, FIG. 10 generally depicts some embodiments of methods to configure the LC cell with more rigid and/or stiffer configuration, so as to withstand the stresses imparted on the LC cell by the tempered SLG layer or layers during manufacture, so as to prevent, reduce, and/or eliminate dark spots. Non-limiting examples include: increasing the thickness of the first sheet of glass (thin glass) in the LC cell; increasing the thickness of the second sheet of glass (e.g. thin glass) in the LC cell; varying the density of spacers (e.g. increasing the number per unit area of spacers in one or more region or regions of the LC cell); varying the modulus of the spacers (e.g. increasing the modulus of the spacers to promote rigidity in the LC area; corresponding the CTE of the first glass sheet in the LC cell to the first glass layer (e.g. thick tempered SLG) in the LC panel (e.g. using Gorilla® Glass or Iris™ Glass as the first sheet of glass and/or second sheet of thin glass); increase LC fill to thereby impart pressurized LC cell (e.g. sealed control volume includes a positive pressure); and/or combinations thereof.

In one embodiment, the thickness of the first glass sheet in the LC cell is not greater than 1 mm thick. In one embodiment, the thickness of the second glass sheet in the LC cell is not greater than 1 mm thick. In one embodiment, the first glass sheet of the LC cell is selected from: Gorilla Glass and Iris Glass when the first glass layer of the LC panel is a tempered SLG. In one embodiment, the second glass sheet of the LC cell is selected from Gorilla Glass and Iris Glass when the second glass layer of the panel is a tempered SLG.

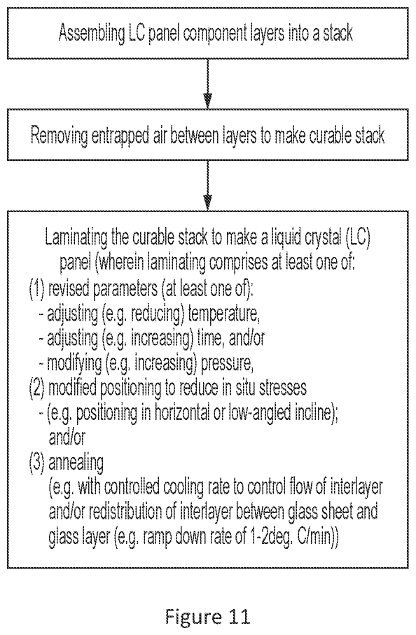

FIG. 11 depicts a flow chart for a method of making an LC panel in accordance with various embodiment of the present disclosure. Referring to FIG. 11, various embodiments of lamination are provided, including: laminating with revised (adjusted) parameters, modifying the position of lamination, and/or annealing (controlled cooling). In some embodiments, laminating is completed at a reduced temperature for a longer duration of time, with optionally increased pressure. In another embodiment, laminating is completed in a non-vertical (e.g. horizontal or low-angled incline) orientation. In some embodiments, the laminating step includes annealing/controlled cooling of the LC panel. As a non-limiting example, controlled cooling includes cooling the LC panel at a temperature (under pressure) of 1-2 degrees C/min until the LC panel is cooled to the target final temperature. In some embodiments, laminating temperature is lowered (e.g. 135 degrees C. down to 125 degrees C., with an extended lamination time for a PVB interlayer. In some embodiments, laminating time is extended at elevated temperature (e.g. for any interlayer) to promote conformity between the first glass layer and second glass layer of the panel (e.g. tempered SLG layers) and the major surfaces of the LC cell (first glass sheet and second glass sheet configured from fusion glass).

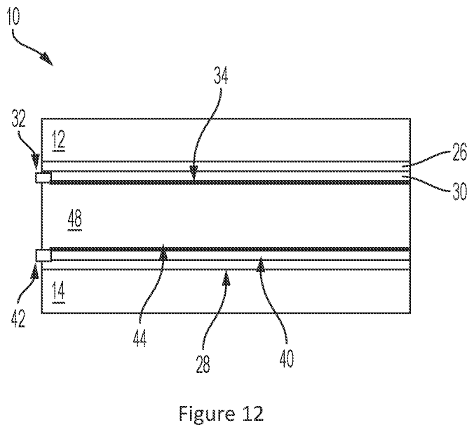

FIG. 12 depicts a schematic view of an embodiment of an LC panel in accordance with various embodiments of the present disclosure. Without wishing to be bound by any particular mechanism or theory, by incorporating a thick interlayer (e.g. first interlayer and/or second interlayer) and/or by changing the composition of the interlayer (e.g. first interlayer and/or second interlayer), the interlayer is tailored to promote with conformity sufficient to address the stresses from the tempered SLG layers, to thereby reduce, prevent, and/or eliminate dark spots from the laminate manufacturing process. In one embodiment, the interlayer thickness (of the first interlayer and/or second interlayer) is less than 2.3 mm (e.g. from 0.76 mm to 2.28 mm). In some embodiments, the interlayer (the first interlayer and/or second interlayer) comprises a low modulus interlayer (e.g. acoustic PVB).

In some embodiments, a low modulus material (i.e. Young's modulus E for loading duration 1 min at 20 degrees C.). In some embodiments, the interlayer comprises a Young's modulus E of not greater than 25 MPa to not less than 1 MPa. In some embodiments, the interlayer comprises a Young's modulus E of not greater than 20 MPa to not less than 1 MPa. In some embodiments, the interlayer comprises a Young's modulus E of not greater than 15 MPa to not less than 2 MPa. In some embodiments, the interlayer comprises a Young's modulus E of not greater than 13 MPa to not less than 2 MPa. In some embodiments, the interlayer comprises a Young's modulus E of not greater than 11 MPa to not less than 3 MPa. In some embodiments, the interlayer comprises a Young's modulus E of not greater than 8 MPa to not less than 1 MPa. In some embodiments, the interlayer comprises a Young's modulus E of not greater than 7 MPa to not less than 1 MPa. In some embodiments, the interlayer comprises a Young's modulus E of not greater than 7 MPa to not less than 2 MPa. In some embodiments, the interlayer comprises a Young's modulus E of not greater than 5 MPa to not less than 3 MPa. In some embodiments, the interlayer comprises a Young's modulus E of not greater than 4 MPa to not less than 1 MPa. In some embodiments, the interlayer comprises a Young's modulus E of not greater than 5 MPa to not less than 2 MPa. In some embodiments, the interlayer comprises a Young's modulus E of not greater than 5 MPa to not less than 3 MPa. One way to determine Young's modulus of elongation is to evaluate in accordance with ASTM D-882.

Some non-limiting examples of low modulus material interlayer that can be utilized in accordance with one or more embodiments of the present disclosure include: Ethylene vinyl acetate (EVA); low modulus polyvinyl butyral (PVB) materials; Saflex Clear (PVB); Trosifol Clear (PVB); Trosifol SC (PVB); and thermoplastic urethane interlayer (TPU).

A non-limiting example of acoustic PVB is Saflex® SG-41, commercially available from Eastman Chemical. In some embodiments, the interlayer (the first interlayer and/or second interlayer) comprises a low viscosity interlayer. For example, the low viscosity interlayer comprises a UV-curable resin (e.g. a non-limiting example of a low viscosity interlayer includes: Uvekol® UV-curable resin from allnex Netherlands B.V.). In some embodiments, the interlayer (the first interlayer and/or second interlayer) comprises an ionomer (e.g. SentryGlas® from Kuraray).

In some embodiments, the interlayer thickness is greater than 0.76 mm (e.g. PVB composition). In some embodiments, the interlayer thickness is 1.52 mm (e.g. PVB composition). In some embodiments, the interlayer thickness is 2.28 mm (e.g. PVB composition).

In some embodiments, a low modulus interlayer comprises thermoplastic polyurethane (TPU). In some embodiments, the low modulus interlayer comprises a thickness of less than 1.3 mm. In some embodiments, the low modulus interlayer comprises a thickness of 0.5 mm. In some embodiments, the low modulus interlayer comprises a thickness in the range of 0.5 mm to not greater than 1.3 mm. In some embodiments, the interlayer comprises a low viscosity UV-curable resin. In some embodiments, the low viscosity interlayer comprises Uvekol®. In some embodiments, a UV-curable resin is pumped into the stack and retained in place with sealing strips, then directed through UV-cure (e.g. provided with sufficient radiation for sufficient time to cure). In some embodiments, the apparatus is UV-cured (e.g. when the interlayer is a UV-curable resin).

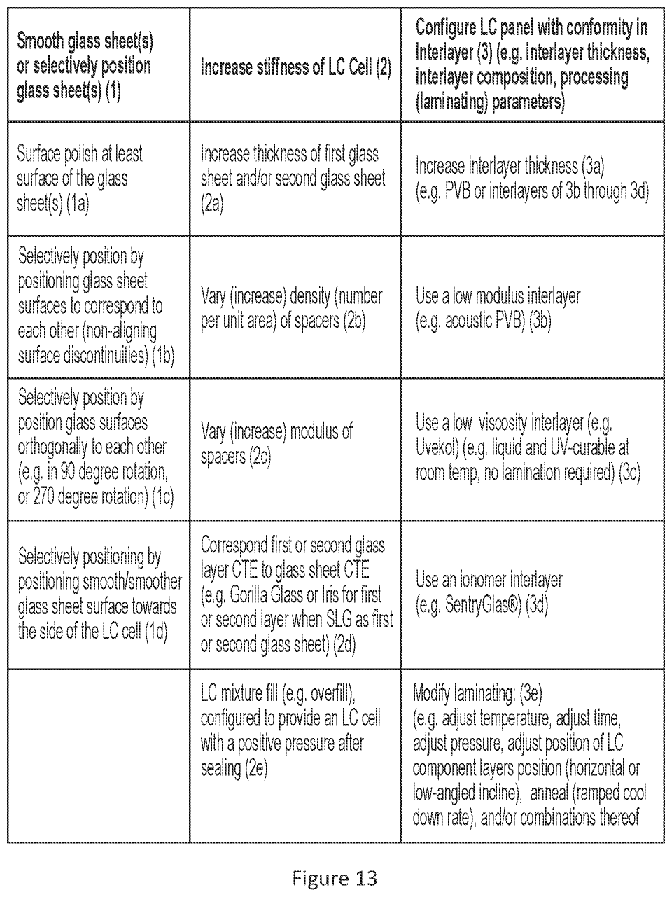

FIG. 13 depicts a table depicting the various embodiments of preventing non-uniform transmissions (e.g. spots, including dark spots or light spots) in an LC panel, in accordance with various embodiments of the present disclosure.

Referring to FIG. 13, in one embodiment, an apparatus or method of making a liquid crystal panel includes: at least one embodiment from (1) is combined with at least one embodiment from (2). Referring to FIG. 13, in one embodiment, an apparatus or method of making a liquid crystal panel includes: at least one embodiment from (1) is combined with at least one embodiment from (3). Referring to FIG. 13, in one embodiment, an apparatus or method of making a liquid crystal panel includes: at least one embodiment from (2) is combined with at least one embodiment from (3).

Referring to FIG. 13, in one embodiment, an apparatus or method of making a liquid crystal panel includes: at least two embodiments from (1) are combined with at least one embodiment from (2). Referring to FIG. 13, in one embodiment, an apparatus or method of making a liquid crystal cell includes: at least two embodiments from (1) are combined with at least one embodiment from (3). Referring to FIG. 13, in one embodiment, an apparatus or method of making a liquid crystal panel includes: at least two embodiments from (2) are combined with at least one embodiment from (3).

Referring to FIG. 13, in one embodiment, an apparatus or method of making a liquid crystal panel includes: at least one embodiment from (1) is combined with at least one embodiment from (2) and at least one embodiment from (3).

Referring to FIG. 13, in one embodiment, an apparatus or method of making a liquid crystal panel includes: at least two embodiments from (1) are combined with at least two embodiments from (2) and at least two embodiments from (3).

Referring to FIG. 13, in one embodiment, an apparatus or method of making a liquid crystal panel includes: (i) (1a); (ii) at least one of (2a), (2b), (2c), and (2d); (iii) optionally (3a), one of (3b), (3c), and (3d); and (iv) if (3b) or (3c), optionally (3e).

Referring to FIG. 13, in one embodiment, an apparatus or method of making a liquid crystal panel includes: (i) (1a); (ii) at least one of (2a), (2b), (2c), (2d); and (iii) optionally (3a), (iv) one of (3b), (3c), and (3d); and (v) if (3b) or (3c), optionally (3e).

Referring to FIG. 13, in one embodiment, an apparatus or method of making a liquid crystal panel includes: (i) (1a) and (ii) at least one selective positioning (1b), (1c), and (1d); (iii) at least one of (2a), (2b), (2c), and (2d); (iv) (3a); and optionally (3e).

Referring to FIG. 13, in one embodiment, an apparatus or method of making a liquid crystal panel includes: (i) (1a); (ii) at least one of (2a), (2b), (2c), and (2d); (iii) (3a), (iv) one of (3b), (3c), and (3d); and (v) if (3b) or (3c), optionally (3e).

Referring to FIG. 13, in one embodiment, an apparatus or method of making a liquid crystal panel includes: (i) at least one selectively positioning (1b), (1c), and (1d); (ii) at least one of (2a), (2b), (2c), and (2d); (iii) (3a); (iv) one of (3b), (3c), and (3d); and (v) if (3b) or (3c), optionally (3e).

Referring to FIG. 13, in one embodiment, an apparatus or method of making a liquid crystal panel includes: (i) at least one selectively positioning (1b), (1c), and (1d); (ii) at least one of (2a) and (2c); (iii) (3a); and (iv) optionally (3e).

Referring to FIG. 13, in one embodiment, an apparatus or method of making a liquid crystal panel includes: (i) (1b), (1c), and (1d); (ii) at least one of (2a), (2b), (2c), (2d), and (iii) (3a), (iv) one of (3b), (3c), and (3d); and (v) if (3b) or (3c), optionally (3e).

Referring to FIG. 13, in one embodiment, an apparatus or method of making a liquid crystal panel includes: (i) (1a) and at least one selectively positioning (1b), (1c), and (1d); (ii) at least one of (2a), (2b), (2c), (2d), and (iii) (3a), one of (3b), (3c), and (3d) and (iv) if (3b) or (3c), optionally (3e).

Referring to FIG. 13, in one embodiment, an apparatus or method of making a liquid crystal panel includes: (i) at least one selective positioning (1b), (1c), and (1d); and (ii) (3a), with (iii) optionally (3e).

Referring to FIG. 13, in one embodiment, an apparatus or method of making a liquid crystal panel includes: (i) at least one selective positioning (1b), (1c), and (1d); and (ii) one of (3b), (3c) and (3d), (iii) optionally, if (ii) is (3b) or (3d), optionally (3e).

Alternatively, liquid crystal (LC) material is sandwiched between two pieces of commercially available fusion formed borosilicate glass, such as Corning® EAGLE XG® to form the liquid crystal cell. However, such glass has thickness <1 mm, and so is not rigid enough to withstand exposure to the wind and snow loads commonly experienced by large-dimensioned windows in architectural applications. As such, liquid crystal windows of the present disclosure include an LC cell having thin glass (e.g. less than 1 mm), which are laminated to thick (>3 mm) pieces of soda lime glass (SLG) for additional strength and/or support. The SLG is tempered (per ASTM C1048) for additional strength and breakage protection, however, the tempering process is known to induce out-of-plane distortion in the SLG, which can be significant, impacting the LC panel.

After lamination, if the thin glass(es) from the LC cell is well-adhered to the SLG, the out-of-plane distortion from the SLG can pull on the thin glass, which may drive stresses acting on the LC cell, including locally increasing the LC cell gap and/or producing undesirable local changes in visual appearance. The LC panel or resulting LC window can have spots of non-uniform transmission, or regions having 2% or greater variation in visible light transmission relative to the average visible light transmission across the visible area of the panel (e.g. dark spots or light spots). Without being bound by any particular mechanism or theory, non-uniform transmission areas or regions are believed to be attributed to a thicker cell gap in the LC cell, which is generated during manufacturing of the LC window.

One or more advantages of using thin glass to fabricate the LC cell include: (a) compatibility with existing LCD fabrication equipment; lower window weight, making it easier to transport and install and lowering overall carbon footprint; higher visible light transmission in the clear state; thinner overall window structures, and/or additional room for gas in an IGU, thereby improving the insulation efficiency.

One or more embodiments of the present disclosure are directed towards configurations and methods for reducing, preventing, and/or eliminating areas or regions of non-uniform transmission (e.g. dark spots or light spots) in an LC panel. Thus, one or more LC panels of the present disclosure are configured with uniform transmission (e.g. regions at no greater than 2% variation in visible light transmission relative to the average visible light transmission across an adjacent area (visible area) of the window).

In some embodiments, dark spots or light spots (spots') are detectable by visual observation (in a static mode of the liquid crystal window, spots, if any are detectable in at least one of the first contrast state and the second contrast state, where the contrast states are an on position and an off position.

In some embodiments, a spot means that transmission of the window in a region is greater than 2% lower transmission in the dark spot region, as compared to the surrounding, non-dark spot region. As a non-limiting example, transmission is measurable with a spectrometer (e.g. percent transmission or visible light transmission).

In one aspect, a method is provided, comprising: assembling a plurality of LC panel component layers to form a stack; removing any entrained air between the component layers of the stack to form a curable stack; laminating the curable stack for a duration of time, at a lamination temperature, and at a pressure to form a liquid crystal window; wherein the liquid crystal window is configured with a uniform transmission.

In some embodiments, a uniform transmission comprises not greater than 2% disparity in a transmission region (e.g. visible light transmission), as compared to adjacent transmission regions.

In some embodiments, uniform transmission is detected via visual observation.

In some embodiments, uniform transmission is detected via spectrophotometer.

The providing step further comprises: assembling further comprises positioning a first glass layer, a first interlayer, an LC cell, a second interlayer, and a second glass layer into a stacked configuration.

In one aspect, an apparatus is provided, comprising: a liquid crystal cell, wherein the liquid crystal cell comprises: a first glass layer, a second glass layer, configured in spaced relation from the first glass layer, and a liquid crystal material comprising an electrically switchable material (e.g. including a first contrast state and a second contrast state) positioned (retained) between the first glass layer and the second glass layer, a plurality of spacers, wherein the spacers are configured to sit between the first glass layer and the second glass layer and among the liquid crystal material, wherein the spacers are configured to maintain a LC gap (e.g. distance from the first glass sheet to the second glass sheet) of the LC cell; a first conductive layer and a second conductive layer, wherein the first conductive layer is configured between the first glass layer and a first side of the LC cell such that the first conductive layer is in electrical communication with the first side of the LC cell, wherein the second conductive layer is configured between the second glass layer and the second LC sidewall such that the second conductive layer is in electrical communication with the second side of the LC cell, a first electrode configured adjacent to a cell perimeter and in electrical communication with the first conductive layer; and a second electrode configured adjacent to the second conductive layer; wherein, the electrodes are configurable to a power source, such that the LC cell is electrically configured to electrically actuate the electrically switchable material in the LC mixture.

In some embodiments, the spacers are configured from a polymer material.

In some embodiments, the first glass layer is a thin glass.

In some embodiments, the first glass layer has a thickness of less than 1 mm.

In some embodiments, the first glass layer has a thickness of not greater than 0.5 mm. In some embodiments, the second glass layer is a thin glass.

In some embodiments, the second glass layer has a thickness of less than 1 mm. In some embodiments, the second glass layer has a thickness of not greater than 0.5 mm.

In some embodiments, the LC gap is not greater than 10 microns.

In some embodiments, the conductive layer comprises ITO and polyimide.

In another aspect, an apparatus is provided, comprising: a liquid crystal cell (LC cell), configured to retain an electrically switchable LC material; a first glass sheet configured along a first side of the LC cell; a second glass sheet configured along a second side of the LC cell; a first interlayer positioned between the first glass sheet and the first side of the LC cell, wherein the first interlayer adheres the first glass layer to the first side of the LC cell; and a second interlayer positioned between the second glass sheet and the second side of the LC cell, wherein the second interlayer is configured to adhere the second glass layer to the second side of the LC cell.

In some embodiments, the apparatus is a laminate.

In some embodiments, the apparatus is a liquid crystal window.

In some embodiments, the liquid crystal window has a surface area of at least 1 foot by at least 2 feet.

In some embodiments, the liquid crystal window has a surface area of at least 2 feet by at least 4 feet.

In some embodiments, the liquid crystal window has a surface area of at least 3 feet by at least 5 feet.

In some embodiments, the liquid crystal window has a surface area of at least 5 feet by at least 7 feet.

In some embodiments, the liquid crystal window has a surface area of at least 7 feet by at least 10 feet.

In some embodiments, the liquid crystal window has a surface area of at least 10 feet by at least 12 feet.

In some embodiments, the apparatus is an architectural liquid crystal window.

In some embodiments, the apparatus is an automotive liquid crystal window.

In some embodiments, the first glass layer comprises a soda lime glass.

In some embodiments, the first glass layer comprises a tempered soda lime glass.

In some embodiments, the first glass layer comprises a thickness of at least 2 mm.

In some embodiments, the first glass layer comprises a thickness of at least 2 mm to not greater than 4 mm.

In some embodiments, the first glass layer comprises a thickness of 3 mm.

In some embodiments, the first glass layer comprises a thickness of 4 mm.

In some embodiments, the second glass layer comprises a soda lime glass.

In some embodiments, the second glass layer comprises a tempered soda lime glass.

In some embodiments, the second glass layer comprises a thickness of at least 2 mm.

In some embodiments, the second glass layer comprises a thickness of at least 2 mm to not greater than 4 mm.

In some embodiments, the second glass layer comprises a thickness of 3 mm.

In some embodiments, the second glass layer comprises a thickness of 4 mm.

In some embodiments, the first interlayer comprises a thickness of not greater than 1 mm.

In some embodiments, the first interlayer comprises a thickness of 0.76 mm.

In some embodiments, the first interlayer comprises a polymer.

In some embodiments, the first interlayer comprises PVB.

In some embodiments, the second interlayer comprises a thickness of not greater than 1 mm.

In some embodiments, the second interlayer comprises a thickness of 0.76 mm.

In some embodiments, the second interlayer comprises a polymer.

In some embodiments, the second interlayer comprises PVB.

In some embodiments, at least one surface of the LC panel comprises a coating.

In some embodiments, at least one surface of the LC panel comprises a low emissivity coating.

In some embodiments, the outer surface of the second glass layer of the LC panel comprises a low emissivity coating. For example, the low emissivity coating can be comprised of a combination of metals and oxides, including non-limiting examples of silicon nitride, metallic silver, silicon dioxide, tin oxide, zirconium oxide, and/or combinations thereof, to name a few.

As some non-limiting examples, the coating includes: a low emissivity coating, an anti-reflective coating; a tint coating; an easy clean coating; or an anti-bird strike coating. In some embodiments, the coating is a partial coating. In some embodiments, the coating is a full coating. In some embodiments (e.g. anti-bird strike coating), the coating is patterned along discrete portions of the surface.

In some embodiments, the laminate comprises a coating on at least one of: a first major surface of the LC panel, a second major surface of the LC panel, and both the first major surface of the LC panel and the second major surface of the LC panel.

In some embodiments, the apparatus is an architectural product.

In some embodiments, the apparatus is an architectural window.

In some embodiments, the apparatus is an automotive window.

With reference to FIGS. 5 through 9c, the following embodiments are provided:

In one aspect, a method is provided, comprising: providing a first glass layer and a second glass layer; wherein the first glass layer comprises a first surface and a second surface, and the second glass layer comprises a first surface and a second surface, surface polishing at least one of: the first surface of the first glass layer; the second surface of the first glass layer; the first surface of the second glass layer; and the second surface of the second glass layer to provide at least one polished layer on at least one of the first glass layer and the second glass layer; assembling a plurality of LC panel component layers to form a stack, wherein the LC panel component layers comprise: the first glass layer; a first interlayer; an LC cell; a second interlayer; and the second glass layer; removing any entrained air between the LC panel component layers of the stack to form a curable stack; laminating the curable stack to form a liquid crystal panel; wherein via the surface polishing step, the liquid crystal panel is configured with a uniform transmission.

In some embodiments, during the assembling step, the at least one polished layer is facing one of: the first interlayer or the second interlayer.

In some embodiments, surface polishing at least one of: the first surface of the first glass layer; the second surface of the first glass layer; and at least one of: the first surface of the second glass layer; and the second surface of the second glass layer to provide at least one polished layer on the first glass layer and at least one polished layer on the second glass layer.

In some embodiments, during the assembling step, the polished layer on the first glass layer is facing the first interlayer and the polished layer on the second glass layer is facing the interlayer.

In some embodiments, the laminating step further comprises heating the curable stack to a lamination temperature for a duration of time.

In some embodiments, the laminating step further comprises applying pressure to the LC panel component layers during lamination.

In some embodiments, the uniform transmission comprises not greater than 2% disparity in a transmission region, as compared to adjacent transmission regions in the LC panel.

In some embodiments, uniform transmission is detected via visual observation.

In some embodiments, uniform transmission is detected via spectrophotometer.

In some embodiments, surface polishing comprises removing peaks extending above 50 microns, as measured from the surface plane of the corresponding first glass layer or second glass layer.

In some embodiments, surface polishing comprises reducing out-of-plane discontinuities in the first glass layer or second glass layer by at least 25%; or at least 50%; or at least 75% when comparing the out-of-plane discontinuities of the polished layer to the same surface of the same glass layer, before polishing.

In another aspect, a method is provided, comprising: assembling a plurality of LC panel component layers to form a stack, wherein the LC panel component layers comprise: a first glass layer having a first surface and a second surface; a first interlayer; an LC cell; a second interlayer; and the second glass layer, having a first surface and a second surface; selectively positioning at least one of: the first glass layer and the second glass layer across the stack to mitigate an additive distortion in the stack from at least one of: the first glass layer and second glass layer; removing any entrained air between the LC panel component layers of the stack to form a curable stack; laminating the curable stack to form a liquid crystal panel; wherein via the selectively positioning step, the liquid crystal panel is configured with a uniform transmission.

In some embodiments, selectively positioning further comprises: orthogonally positioning the first glass layer from a second glass layer to selectively position an interlayer-facing surface of the first glass layer with an interlayer-facing surface of the second glass layer.

In some embodiments, selectively positioning further comprises: determining a smoother side from the first surface and the second surface of the first glass layer, where smoother comprises at least one of: fewer out-of-plane discontinuities and/or lower out-of-plane discontinuities, and positioning the smoother side towards the first interlayer.

In some embodiments, selectively positioning further comprises: determining a smoother side from the first surface and the second surface of the second glass layer, where smoother comprises at least one of: fewer out-of-plane discontinuities and/or lower out-of-plane discontinuities, and positioning the smoother side of the second glass layer towards the second interlayer.

In some embodiments, selectively positioning further comprises: determining a smoother side from the first surface and the second surface of the first glass layer, where smoother comprises at least one of: fewer out-of-plane discontinuities and/or lower out-of-plane discontinuities, positioning the smoother side towards the first interlayer; determining a smoother side from the first surface and the second surface of the second glass layer, where smoother comprises at least one of: fewer out-of-plane discontinuities and/or lower out-of-plane discontinuities, and positioning the smoother side of the second glass layer towards the second interlayer.

In some embodiments, selectively positioning further comprises: determining a direction of bow in the first glass layer; determining a direction of bow in the second glass layer; and positioning the first glass layer and the second glass layer to align bow in a corresponding direction coincident between bow in each of the first glass layer and the second glass layer, thereby mitigating additive bow distortion between the first glass layer and the second glass layer in the stack.

In some embodiments, the method comprises: surface polishing at least one of: the first surface of the first glass layer; the second surface of the first glass layer; the first surface of the second glass layer; and the second surface of the second glass layer to provide at least one polished layer on at least one of the first glass layer and the second glass layer.

In some embodiments, during the assembling step, the at least one polished layer is facing one of: the first interlayer or the second interlayer.

In some embodiments, the method further comprises: surface polishing at least one of: the first surface of the first glass layer; the second surface of the first glass layer; and at least one of: the first surface of the second glass layer; and the second surface of the second glass layer to provide at least one polished layer on the first glass layer and at least one polished layer on the second glass layer.

In some embodiments, during the assembling step, the polished layer on the first glass layer is facing the first interlayer and the polished layer on the second glass layer is facing the interlayer.

In some embodiments, the uniform transmission comprises not greater than 2% disparity in a transmission region, as compared to adjacent transmission regions in the LC panel.

In another aspect, a method is provided, comprising: providing a first glass layer and a second glass layer; wherein the first glass layer has a first surface and a second surface, and the second glass layer has a first surface and a second surface, surface polishing at least one of: the first surface of the first glass layer; the second surface of the first glass layer; the first surface of the second glass layer; and the second surface of the second glass layer to provide at least one polished layer on at least one of the first glass layer and the second glass layer; assembling a plurality of LC panel component layers to form a stack, wherein the LC panel component layers comprise: the first glass layer and the second glass layer, wherein at least one of the first glass layer and second glass layer comprise a polished surface; a first interlayer; an LC cell; a second interlayer; wherein the polished surface towards the corresponding first interlayer or second interlayer and selectively positioning at least one of: the first glass layer and the second glass layer across the stack to mitigate an additive distortion in the stack from at least one of: the first glass layer and second glass layer; removing any entrained air between the LC panel component layers of the stack to form a curable stack; laminating the curable stack to form a liquid crystal panel; wherein via the surface polishing and selectively positioning steps, the liquid crystal panel is configured with a uniform transmission.

With reference to FIG. 10, the following embodiments are provided.

In one aspect, a method is provided, comprising: configuring an LC cell to undergo lamination without imparting distortion in a cell gap of the LC cell, assembling a plurality of LC panel component layers to form a stack, wherein the stack is configured with the LC cell, a first glass layer, a second glass layer, a first interlayer and a second interlayer, wherein the first interlayer is positioned between the first glass layer and first major surface of the LC cell, and the second interlayer is positioned between the second glass layer and the second major surface of the LC cell; removing any entrained air between the component layers of the stack to form a curable stack; laminating the curable to form a liquid crystal panel, wherein via the LC cell configuration, the liquid crystal panel is configured with a uniform transmission.

In some embodiments, configuring an LC cell to undergo lamination without imparting distortion in a cell gap of the LC cell, comprises using a first glass sheet comprising: a fusion formed glass having a thickness of 0.5 mm to not greater than 1 mm.

In some embodiments, configuring an LC cell to undergo lamination without imparting distortion in a cell gap of the LC cell, comprises using a second glass sheet comprising: a fusion formed glass having a thickness of 0.5 mm to not greater than 1 mm.

In some embodiments, the LC cell comprises a first glass sheet having a thickness greater than the second glass sheet.

In some embodiments, the first glass sheet and second glass sheet have the same thickness.

In some embodiments, the LC cell comprises a plurality of spacers configured in the cell gap in a number per unit area of spacers sufficient to achieve: (1) maintaining the cell gap of the LC cell; and (2) increasing stiffness of the LC cell to reduce flexibility while being pulled by the first glass layer and the second glass layer in the LC panel, while maintaining the LC region functionality as an actuating material.

In some embodiments, the LC cell comprises a plurality of spacers configured in one or more locations in the LC region to define the cell gap, with the spacers having a modulus of elongation sufficient to impart rigidity to the LC region to prevent deformation of the cell gap in response to the laminating step.

In some embodiments, the first glass sheet of the LC cell is selected with a coefficient of thermal expansion (CTE) corresponding to the CTE of the first glass layer in the LC panel.

In some embodiments, the first glass sheet is selected from the group of Corning® EAGLE XG® and Iris® Glass when the first layer is soda lime glass.

In some embodiments, the second glass sheet of the LC cell is selected with a coefficient of thermal expansion (CTE) corresponding to the CTE of the second glass layer in the LC panel.

In some embodiments, the second glass sheet is selected from the group of Corning Gorilla® Glass, EAGLE XG, and Iris Glass when the second layer is soda lime glass.

In some embodiments, the method comprises providing a pressurized LC cell.

In some embodiments, the method comprises providing an LC cell overfilled with liquid crystal material and/or a plurality of spacers to impart a positively pressured LC cell when sealed.

In some embodiments, the uniform transmission comprises not greater than 2% disparity in a transmission region as compared to adjacent transmission regions.

In some embodiments, uniform transmission is detected via visual observation.

In some embodiments, uniform transmission is detected via spectrophotometer.

With reference to FIGS. 11 and 12, the following embodiments are provided.

In one aspect, a method is provided, comprising: assembling a plurality of LC panel component layers to form a stack, wherein the stack is configured with the LC cell, a first glass layer, a second glass layer, a first interlayer and a second interlayer, wherein each of the first interlayer and second interlayer are configured to be conformal layers; removing any entrained air between the component layers of the stack to form a curable stack; bonding the curable stack to bond the first glass layer to the first major surface the LC cell via a first conformal interlayer and to bond the second glass layer to the second major surface of the LC cell via the second conformal interlayer to thereby form a liquid crystal panel; wherein, via the first conformal interlayer and the second conformal interlayer, the liquid crystal panel is configured with a uniform transmission.

In some embodiments, bonding comprises laminating.

In some embodiments, the first interlayer and second interlayer are configured of laminable interlayers selected from the group consisting of a polymer; a low modulus polymer material; an ionomer, and combinations thereof.

In some embodiments, at least one of the first interlayer and second interlayer are an ionomer.

In some embodiments, at least one of the first interlayer and second interlayer are SentryGlas®.

In some embodiments, at least one of the first interlayer and second interlayer are a low modulus polymer.

In some embodiments, at least one of the first interlayer and second interlayer are at least one of: ethylene vinyl acetate (EVA); low modulus polyvinyl butyral (PVB) materials; Saflex Clear (PVB); Trosifol Clear (PVB); Trosifol SC (PVB); and thermoplastic urethane interlayer (TPU).

In some embodiments, at least one of the first interlayer and second interlayer are a low viscosity interlayer, comprising a liquid state at room temperature.

In some embodiments, at least one of the first interlayer and second interlayer comprise a Uvekol.

In some embodiments, the bonding step comprises curing at room temperature.

In some embodiments, the bonding step comprises UV-curing at room temperature.

In some embodiments, at least one of the first interlayer and second interlayer comprise a thickness of greater than 076 mm.

In some embodiments, at least one of the first interlayer and second interlayer comprise a thickness of between 1 mm and not greater than 2.3 mm.

In some embodiments, the first interlayer and second interlayer comprise a PVB.

In some embodiments, the uniform transmission comprises not greater than 2% disparity in a transmission region (e.g. visible light transmission), as compared to adjacent transmission regions.

In some embodiments, uniform transmission is detected via visual observation.

In some embodiments, wherein uniform transmission is detected via spectrophotometer.

In one aspect, an apparatus is provided, comprising: a liquid crystal cell (LC cell), configured to retain an electrically switchable LC material; a first glass layer configured along a first side of the LC cell; a second glass layer configured along a second side of the LC cell; a first conformal interlayer positioned between the first glass layer and a first side of the LC cell, wherein the first interlayer adheres the first glass layer to the first side of the LC cell; and a second conformal interlayer positioned between the second glass layer and the second side of the LC cell, wherein the second interlayer is configured to adhere the second glass layer to the second side of the LC cell.

In some embodiments, the apparatus is a laminated structure.

In some In some embodiments, the first conformal interlayer and second conformal interlayer comprise a UV curable interlayer material that is liquid at room temperature.

In some embodiments, first conformal interlayer and second conformal interlayer comprise a Uvekol.

In some embodiments, at least one of the first conformal interlayer and second conformal interlayer comprises a low modulus polymer material.

In some embodiments, the low modulus polymer material is selected from the group consisting of: Ethylene vinyl acetate (EVA); low modulus polyvinyl butyral (PVB) materials; Saflex Clear (PVB); Trosifol Clear (PVB); Trosifol SC (PVB); and thermoplastic urethane interlayer (TPU).

In some embodiments, at least one of the first conformal interlayer and second conformal interlayer comprises an ionomer material.

In some embodiments, at least one of the first conformal interlayer and second conformal interlayer comprises an ionomer material.

In some embodiments, at least one of the first conformal interlayer and second conformal interlayer has a thickness of 1 mm to not greater than 2.5 mm.

In some embodiments, the first conformal and second conformal interlayer comprise a thickness of between 1.3 mm and 2.3 mm.

In some embodiments, the first conformal interlayer and the second conformal interlayer comprise PVB.

In some embodiments, the apparatus is a liquid crystal panel.

In some embodiments, the apparatus further comprises an LC window, the LC window configured with a frame and a seal connecting an outer edge of the LC panel to the frame, wherein the frame and seal are perimetrically configured around the outer edge of the LC panel.

In some embodiments, the liquid crystal window has a surface area of 3 feet by 5 feet.

In some embodiments, the liquid crystal window has a surface area of 5 feet by 7 feet.

In some embodiments, the liquid crystal window has a surface area of 7 feet by 10 feet.

In some embodiments, the liquid crystal window has a surface area of 10 feet by 12 feet.

In some embodiments, the apparatus is an architectural LC panel.

In some embodiments, apparatus is an automotive liquid crystal panel.

In some embodiments, the apparatus comprises a coating on at least one of: the first glass layer and the second glass layer.

In some embodiments, the coating comprises at least one of: a low emissivity coating, an anti-reflective coating; a tint coating; an easy clean coating; or an anti-bird strike coating.

In one aspect, a method is provided, comprising: assembling a plurality of LC panel component layers to form a stack, wherein the stack is configured with the LC cell, a first glass layer, a second glass layer, a first interlayer and a second interlayer; removing any entrained air between the component layers of the stack to form a curable stack; laminating the curable stack to bond the first glass layer to the first major surface the LC cell via a first interlayer and to bond the second glass layer to the second major surface of the LC cell via the second interlayer to thereby form a liquid crystal panel; wherein, via the laminating step, the liquid crystal panel is configured with a uniform transmission.

In some embodiments, laminating further comprises annealing the liquid crystal panel to provide controlled cooling to the first interlayer and second interlayer, to thereby promote conformation of: the first interlayer to the first layer of glass and first major surface of the LC cell and the second interlayer to the second layer of glass and the second major surface of the LC cell.

In some embodiments, laminating further comprises cooling the LC panel at controlled ramp rate cooling rate to a target temperature.

In some embodiments, laminating further comprises cooling the LC panel at controlled ramp down rate of not greater than 2 degrees C./min.

In some embodiments, laminating further comprises cooling the LC panel at controlled ramp down rate of between at least 1 degree C./min and not greater than 5 degrees C./min.

In some embodiments, laminating further comprises cooling the LC panel at controlled ramp down rate of between at least 1 degree C./min and not greater than 3 degrees C./min.

In some embodiments, the laminating step further comprises positioning laminated the curable stack in a substantially horizontal configuration, such that the individual the LC cell components are configured in a vertically stacked manner.

In some embodiments, the laminating step further comprises positioning laminated the curable stack in an angled configuration no greater than 15% incline, as compared to a substantially horizontal configuration.

In some embodiments, the laminating step comprises at least one of: imparting a pressure on the outer-facing surfaces of the curable stack, including at least the first glass layer and the second glass layer.

Many variations and modifications may be made to the above-described embodiments of the disclosure without departing substantially from the spirit and various principles of the disclosure. All such modifications and variations are intended to be included herein within the scope of this disclosure and protected by the following claims.

### COMPONENTS LIST

Window 100
Frame 16
Seal 18
LC panel 10
First glass layer (e.g. thick tempered SLG, thickness of >3 mm) 12
Second glass layer (e.g. thick tempered SLG, thickness of >3 mm) 14
LC cell 20
First side (major surface) of LC cell 22
First interlayer 26
First glass sheet 30
First electrode 32
First conductive layer 34
LC region (includes LC mixture and spacers) 48
Spacers 38
LC mixture (includes LC host(s), molecule(s), dye(s), additives) 36
Second conductive layer 44
Second electrode 42
Second glass sheet 40
Second side (major surface) of LC cell 24
Second interlayer 28
Coating (e.g. Low E coating) 46
LC region seal 52
50 example of mura/discontinuous region/non-uniformity
54 cell gap

1. An apparatus, comprising:
a. a liquid crystal cell (LC cell) having a first surface and a second surface, configured to retain an electrically switchable LC material, wherein the LC cell comprises:
i. a first glass sheet having a thickness of 0.5 mm to not greater than 1 mm;
ii. a second glass sheet having a thickness of between 0.5 to not greater than 1 mm;
iii. wherein the first glass sheet and second glass sheet are configured in spaced relation with the electrically switchable LC material configured therebetween;
b. a first glass layer attached to a first side of the LC cell via a first interlayer;
c. a second glass layer attached to a second side of the LC cell via a second interlayer; wherein the first interlayer and second interlayer are selected from:
a UV curable interlayer material; a low modulus interlayer material; an ionomer and
d. at least one polished layer on at least one of:
i. the first glass layer surface in contact with the first interlayer and
ii. the second glass layer surface in contact with the second interlayer; and
e. wherein the first glass sheet is selected to have a coefficient of thermal expansion (CTE) to correspond to the CTE of the first glass layer and the second glass sheet is selected to have a coefficient of thermal expansion (CTE) to correspond to the CTE of the second glass layer.

2. The apparatus of claim 1, wherein both the first glass layer and second glass layer comprise a surface polished layer.

3. The apparatus of claim 1, wherein the first glass sheet and second glass sheet comprise a fusion formed glass.

4. The apparatus of claim 1, wherein at least one of the first glass sheet and second glass sheet is selected with a coefficient of thermal expansion (CTE) to correspond to the CTE of at least one of the first glass layer and the second glass layer.

5. (canceled)

6. The apparatus of claim 1, wherein the first glass sheet and second glass sheet comprise a strengthened glass or an unstrengthened glass.

7. The apparatus of claim 1, wherein the first glass sheet and second glass sheet comprise an alumino-borosilicate glass.

8. The apparatus of claim 1, wherein the first glass layer and second glass layer comprise a float glass.

9. The apparatus of claim 1, wherein the first glass layer and second glass layer comprise a soda lime glass.

10. (canceled)

11. The apparatus of claim 1, wherein the first interlayer and second material are the same material.

12. The apparatus of claim 1, wherein the first interlayer and second interlayer are different materials.

13. The apparatus of claim 1, wherein the first interlayer and second interlayer each have a thickness ranging between 0.5 mm and 2.3 mm.

14. The apparatus of claim 1, wherein the first interlayer and second interlayer have the same thickness.

15. The apparatus of claim 1, wherein the first interlayer and second interlayer have different thicknesses.

16.-83. (canceled)

84. A method, comprising:
assembling a plurality of LC panel component layers to form a stack, wherein the LC panel component layers comprise:
a first glass layer having a first surface and a second surface;
a first interlayer;
an LC cell having a first glass sheet and a second glass sheet, wherein the glass sheets are configured in spaced relation from each other such that an LC functional material is configured therebetween;
a second interlayer; and
the second glass layer, having a first surface and a second surface;
selectively positioning at least one of: the first glass layer and the second glass layer across the stack to mitigate an additive distortion in the stack from at least one of: the first glass layer and second glass layer;
removing any entrained air between the LC panel component layers of the stack to form a curable stack;
curing the curable stack to form a liquid crystal panel,
wherein at least one of:
the first glass sheet and second glass sheet are each configured with a CTE to correspond to a respective CTE of the first glass layer and second glass layer; and
wherein the first glass sheet and second glass sheet are each configured with a thickness ranging from at least 0.5 mm to not greater than 1 mm.

85. The method of claim 84, wherein selectively positioning further comprises at least one of:
orthogonally positioning the first glass layer from a second glass layer to selectively position an interlayer-facing surface of the first glass layer with an interlayer-facing surface of the second glass layer;
determining a smoother side from the first surface and the second surface of the first glass layer, where smoother comprises at least one of: fewer out-of-plane discontinuities and/or lower out-of-plane discontinuities, and positioning the smoother side towards the first interlayer;
determining a smoother side from the first surface and the second surface of the second glass layer, where smoother comprises at least one of: fewer out-of-plane discontinuities and/or lower out-of-plane discontinuities, and positioning the smoother side of the second glass layer towards the second interlayer; and
determining a smoother side from the first surface and the second surface of the first glass layer, where smoother comprises at least one of: fewer out-of-plane discontinuities and/or lower out-of-plane discontinuities,
positioning the smoother side towards the first interlayer;
determining a smoother side from the first surface and the second surface of the second glass layer, where smoother comprises at least one of: fewer out-of-plane discontinuities and/or lower out-of-plane discontinuities, and
positioning the smoother side of the second glass layer towards the second interlayer.

86. The method of claim 83,
wherein curing the curable stack to form a liquid crystal panel, further comprises laminating and controllably cooling the stack via annealing at a cooling ramp rate, wherein:
the first interlayer and second interlayer are each selected from: a UV curable interlayer material; a low modulus interlayer material; an ionomer, and combinations thereof; and
wherein the first glass interlayer and second interlayer are each configured with a thickness ranging from at least 0.5 mm to not greater than 2.3 mm.
